(19) United States
(12) Patent Application Publication
(10) Pub. No.: US 2006/0029914 A1
(43) Pub. Date: Feb. 9, 2006

(54) Keyboarding glove and method to teach keyboarding skills

(76) Inventors: Chris Dietrick, Anderson, IN (US); Teresa Knight, Anderson, IN (US)

Correspondence Address: RITCHISON LAW OFFICES, PC, 115 EAST NINTH STREET - SUITE A, ANDERSON, IN, 46016-1507, US

(21) Appl. No.: 11/199,054

(22) Filed: Aug. 8, 2005

Related U.S. Application Data
(60) Provisional application No. 60/600,028, filed on Aug. 9, 2004.

(51) Int. Cl. G09B 13/00

(52) U.S. Cl. 434/227

(57) ABSTRACT

A device for and a method of teaching keyboarding skills, called a KEYBOARD RIGHT GLOVE AND METHOD are disclosed that relate to the field of educational and teaching devices and methods. More particularly the disclosure relates to a glove-like device used with other visual, audio, and video devices. These devices are used in a unique method (process or manner) of training and educating various age groups in the skills and use of a keyboard used with computer systems. In this age of rapid technological progress, all age groups, young and old, are faced with a need to be proficient in the use of keyboards for data entry and information exchange. This KEYBOARD RIGHT GLOVE AND METHOD addresses this need.

### CROSS-REFERENCE TO RELATED APPLICATIONS

This application claims the benefit of Provisional Patent Application Ser. No. 60/600,028 filed Aug. 9, 2004 by Chris Dietrick and Teresa Knight and titled “Keyboarding Glove and Method to Teach Keyboarding Skills”.

The present invention, KEYBOARD RIGHT GLOVE AND METHOD TO TEACH KEYBOARDING SKILLS relates to the field of educational and teaching devices and methods. More particularly the invention relates to a product and process, manner, or method of training and educating various age groups in the skills and use of a keyboard used with computer systems. In this age of rapid technological progress, all age groups, young and old, are faced with a need to be proficient in the use of keyboards for data entry and information exchange.

### FEDERALLY SPONSORED RESEARCH

None.

### SEQUENCE LISTING OR PROGRAM

None.

### BACKGROUND—FIELD OF INVENTION

The present invention primarily relates to the devices used and methodologies incorporated in the instruction and reinforcement of keyboarding skills across all age groups.

A. Introduction of the Problems Addressed:

Extensive brain research supports the need for integrating the visual, auditory, and kinesthetic modes of learning simultaneously. This is multi-sensory learning at its best. This simultaneous integration of these three learning modes is proven to be successful for ALL students, especially those with learning disabilities and dyslexia.

Current scientific research from the National Institute of Child Health and Human Development and the National Reading Panel has validated that the most effective approach to teach reading to both beginning and struggling students is the Phonics First Orton-Gillingham program, which is a systematic and sequential phonics program which incorporates the simultaneous use of the visual, auditory, and kinesthetic (tactile) methods of learning. This KEYBOARD RIGHT GLOVE AND METHOD is founded and based on these same principles—a sequential system utilizing the visual, auditory, and kinesthetic teaching methods.

Learning institutes and organizations that support similar methods as described here for other types of learning, not keyboarding, include:

1. Institute for Multi-Sensory Education,

2. The National Institute of Child Health and Human Development,

3. Cerbranetics Institute,

4. Davis Research Foundation,

5. Developmental Delay Resources,

6. Dyscalculia,

7. International Dyslexia Society,

8. Learning Disabilities Association,

9. National Center for Learning Disabilities, and

10. Orton-Gillingham

There are recent “breakthroughs” in education in the field of neuroscience or brain research. Dr. Gordon Shaw, a retired physicist, who became interested in the connections between music and mathematics conducted research which concluded that the integration of music with mathematics (rhythmic exercises such as used with KEYBOARD RIGHT GLOVE and method) gained considerable growth in spatial temporal reasoning. This growth expanded to their performance in math and science. Even IQs became higher. His testing integrated the visual, auditory, and kinesthetic/tactile. Some of his conclusions were:
A. Experience shapes the brain. The brain is the only organ in the body that shapes itself from outside experience.
B. Memory is not stored in a single location in the brain. When an experience enters the brain, it is “disconstructed” and distributed all over the cortex.
C. Memory is not static. It would be nice if memory were a matter of experiencing something once and then retrieving it at a later date in exactly the same way; it is the dynamic. It decays naturally over time as new experiences infiltrate older ones concepts as well as retention. (This device and method utilizes visualizing, symbolizing, singing, semantic mapping, simulating and devising mnemonics through the integration of the visual, auditory, kinesthetic, singing, rhythm, etc.)
D. Memory is not unitary.

(1) Declarative Memory is everyday memory, the conscious ability to recall what one ate for breakfast yesterday, the names of ones favorite musicians, the formula for finding the area of a rectangle. It is information that one person can declare.

(2) Procedural Memory refers to skills and habits that one engages in without conscious recall, such as driving a car, decoding words, touch typing, playing the piano, etc. Procedural learning requires many repetitions over a period of time; in fact there is no other way to learn them. Repetition, however, generally is not an efficient way to learn or retain declarative information.

(3) Understanding the differences between these two types of memory—declarative and procedural—is essential in designing classroom instruction and practice. Rote rehearsal is essential for procedural memory, while elaborative rehearsal strategies are much more effective for declarative.
E. Emotion is a primary catalyst in the learning process. Some of the most important findings from neuroscience have elucidated the role of emotion in learning and memory. Emotional responses, however, can have the opposite effect if situations contain elements that a person perceives to be threatening. Under these conditions, emotion is dominant over cognition and the rational/thinking part of the brain is less efficient. The environment must be physically and psychologically safe for learning. (The KEYBOARD RIGHT GLOVES and method is safe in these areas and fun!)

B. Prior Art

Historically, the prior art typing and keyboarding “help-tools” and methods have failed to incorporate many of the teaching improvements described above with keyboarding or typing instruction. Importantly, never has any prior art in itself or in view of other devices and methods provided a solution in one system or method to virtually address all the above stated problems. The prior art discovered to date fails to teach all the features and capabilities of the KEYBOARD RIGHT GLOVE AND METHOD TO TEACH KEYBOARDING SKILLS in respect to the education and training devices or methodology.

There are examples of prior art attempting to improve typing skills that were first seen in the Nineteenth Century. Typing assist “rings” were taught in U.S. Pat. No. 623,966 issued to Barkley (May 2, 1899). This shows a set of four rings on each hand, none on the thumbs. There is no mention of a centering position with the devices or the method suggested. No discussion is made of audio or tactile enhancements. Several years later another assist device is presented. Here in U.S. Pat. No. 2,570,908 (Oct. 9, 1951) the inventor Behr shows a strap-on device worn on each hand with a “marked placard” extending along each of four fingers. No teaching of markings or assists to aid with thumb use and no centering of the hands to a home position is noted. This art shows a very busy and complex set of markings. The strap and placard appear stiff and awkward.

A U.S. Pat. No. 3,277,587 by Holcombe (Oct. 11, 1966) teaches a complex, tactile teaching device for touch typing, piano and other activities. This complex system does teach some benefits of tactile, but incorporates a series of rings and wiring interconnecting each hand and digits. The device and system teaches an instructor's keyboard interconnected with the student's keyboard. The student re-acts to the instructor's input and mimics or duplicates an input. Self study and a simple device is not shown. Another example of teaching typing and language skills surfaced with U.S. Pat. No. 3,501,849 by Olsen (Mar. 24, 1970). This taught a series of colored rings to be worn on the fingers and thumbs. These colors and differentiating designs on the rings in turn had specific areas or sectors on the keyboard which correlated to the colors and designs. Underprivileged children were the targeted market. Audio and tactile improvements were not discussed. Primarily, this system focused on a rote exercise scheme.

Other functional utility patents for typewriter and keyboard instruction continued in the 1980's and 1990's. AvGavaar teaches a series of ferromagnetic tips attached to fingertips. In U.S. Pat. No. 4,465,477 (Aug. 14, 1984) these tips are arranged in alternating north and south poles and correlated with the keyboard key locations. Tips are then repelled and attracted by the resultant magnetic actions of the tips and the keyboard keys. This is a novel approach but does not teach inter reinforcement by a tactile, audio, and video system shown with the new KEYBOARD RIGHT GLOVE AND METHOD. Another strap-on placard is taught by Ladner, et al. in U.S. Pat. No. 4,909,739 (Mar. 20, 1990). Ladner taught and described colored placards with large overlays that covered the keyboard in order to facilitate learning. No audio and video was described that specifically correlated to the strap-on markings.

Another instructional assist for inputting data to a keyboard or like receiver is shown by Dixon in U.S. Pat. No. 5,314,337 (May 24, 1994). Here stick-on appliques are taught as part of the method and apparatus. These colored and designed appliques correlate to similar colors and designs on keyboards or other data input devices. This teaches multiple appliques as compared to the simple gloves in the present KEYBOARD RIGHT GLOVE AND METHOD. The multi-piece appliques require more complex set-up and training as to the use of the system when compared to the KEYBOARD RIGHT GLOVE AND METHOD. Another glove device is displayed in a U.S. Pat. No. 5,486,112 (Jan. 23, 1996) by Troudet et al. which teaches a glove apparatus that incorporates many and varied computing devices within the glove. This highly sophisticated and complex design is a series of full-hand gloves that portray letters, art, language, ring devices and fully integrated computational interface devices. The tactile advantage and use with a keyboard as taught in the KEYBOARD RIGHT GLOVE AND METHOD is not discussed. This simple KEYBOARD RIGHT is not mentioned or anticipated in Troudet's teachings.

A ring system extended onto fingers only is taught by Troudet in U.S. Pat. No. 5,507,649 (Apr. 6, 1996). This shows rings with both letters and Braille attached. Several other configurations are discusses but does not anticipate the KEYBOARD RIGHT GLOVE AND METHOD. Other educational systems by Troudet are included in U.S. Pat. No. 5,554,032 (Sep. 10, 1996) and U.S. Pat. No. 5,571,020 (Nov. 5, 1996). Like the other Troudet devices and systems, highly complex systems and ring devices are shown which do not anticipate the KEYBOARD RIGHT GLOVE AND METHOD in any observed manner.

A colored or designed glove device is taught by Mayhue et al. in U.S. Pat. No. 6,089,872 (Jul. 18, 2000). This device shows only colors and cross-hatch designs, no letters or positions. It describes teaching rows but not the specific group of letters, numbers or characters. It shows the ends of digits available for tactile content, but does not suggest audio and video reinforcement of the keyboarding skills. One KeyRight device was found that offered for sale (by Quarrion Documentation and Training in Bendigo, Victoria, Australia). This device was a colored keyboard to improve some visual control of keyboard entry but taught no use of instructional audio, video, or correlated gloves for use with the keyboard.

None of the prior art discovered to date teaches all the features and capabilities of the KEY BOARD RIGHT GLOVE AND METHOD to teach keyboarding skills in respect to the education and training devices or methodology.

### SUMMARY OF THE INVENTION

The KEYBOARD RIGHT GLOVE AND METHOD TO TEACH KEYBOARDING SKILLS is the DEVICE AND METHOD described in this application. As a foundation a set of flash cards of capital and small case letters for young learners is required to insure that the child recognizes each letter prior to using the program. Then, the KEYBOARD RIGHT GLOVES are the major device used by the students. Finally, the whole method is interwoven with the learning process by an interactive means. A CD-Rom is used with the new typing gloves to incorporate the auditory, visual, and kinesthetic/tactile modes of learning at the same time. The self-running CD-Rom will flash colorful letters on the screen simultaneously as the vocal music is playing to tell the student what letters to type. This simultaneous integration of the auditory, visual, kinesthetic/tactile will promote more in-depth learning and retention of the concepts taught.

A key element of this method is the continuous repetition of skills introduced. Each new skill that is introduced builds on the previous skill introduced. Throughout this program there is repetition of the skills prior to adding a new skill. Example: Skill A is introduced and practiced. Skill B is introduced, and then Skill A and Skill B are practiced. Skill C is introduced; and then Skills A, B, and C are practiced.

### OBJECTS AND ADVANTAGES

Accordingly, there are several objects and advantages of the KEYBOARD RIGHT GLOVE AND METHOD TO TEACH KEYBOARDING SKILLS. There currently exists teaching aids and keyboarding devices that are unidirectional and limited to one or just a very few of the teaching techniques considered here. This product and method is comprehensive and fully inclusive of the latest and broad range of proven educational methods common to other fields of instruction. The glove device is simple and plain in its design yet complete to teach and reinforce keyboarding across a broad age group. This KEYBOARD RIGHT GLOVE AND METHOD TO TEACH KEYBOARDING SKILLS provides an improvement because it is designed to be a complete learning system and aid to the classroom, work and home instruction learning environments. The advantages that are provided here will be fully evident to one skilled in the art of education and training, especially in the field of keyboarding, typing and computer skills once the full detailed description of the embodiment, the operation and the drawings are presented below.

One advantage of this KEYBOARD RIGHT GLOVE and method over others in the field is its Full Kinesthetic system. It incorporates the glove with Music/visual/audio/tactile components of the instruction.

Another advantage is that the KEYBOARD RIGHT GLOVE and method reinforces learning and skills that are important in society now and for the future. Keyboarding is a way of life.

A further advantage is the inexpensive design. The glove and the CDs have a cost advantage once tooled and in place for manufacturing. They will be relatively low cost compared to other keyboarding assist devices.

Additional advantages of the KEYBOARD RIGHT GLOVE and method are that it is for all ages, simple and a repeatable process.

Another advantage is that with the full spectrum of the kinesthetic used in this KEYBOARD RIGHT GLOVE and method is that it is high energy learning which helps emotionally keep the student involved and open to learning.

Finally, other advantages and additional features of the present KEYBOARD RIGHT GLOVE and method will be more apparent from the accompanying drawings and from the full description below. For one skilled in the art of keyboarding and computer teaching and instruction it is readily understood that the features shown in the examples with this new device and method are readily adapted to other types of inventions which are associated with education and training.

### DESCRIPTION OF THE DRAWINGS

The accompanying drawings, which are incorporated in and constitute a part of this specification, illustrate an embodiment of the present KEYBOARD RIGHT GLOVE AND METHOD TO TEACH KEYBOARDING SKILLS that is preferred. The drawings together with the summary description given above and a detailed description given below serve to explain the principles of the invention. It is understood, however, that the new device is not limited to the precise arrangements and instrumentalities shown.

FIG. 1 is PHOTOGRAPH of the main part of the actual invention—a KEYBOARD RIGHT GLOVE.

FIG. 2 is a PHOTOGRAPH of the actual invention—a KEYBOARD RIGHT GLOVE with significant parts and components identified.

FIG. 3 is a PHOTOGRAPH of the original sample and prototype glove of the actual invention—a KEYBOARD RIGHT GLOVE.

FIG. 4 is a DIAGRAM of the major component used with the KEYBOARD RIGHT GLOVE in the advanced method to teach keyboard skills to all age groups.

FIGS. 5—A through I are screens from the actual interactive demonstration Compact Disc of the interactive keyboard instruction method described herein.

FIG. 6 is a table describing the various groups that benefit from the KEYBOARD RIGHT GLOVE and METHOD.

FIGS. 7—A through D are PHOTOGRAPHS of the practice keyboard being used by a student.

FIGS. 8—A through C are diagrams and PHOTOGRAPHS of the gloves and methods used in a computer/keyboarding lab.

FIGS. 9—A through C are diagrams and PHOTOGRAPHS of instructor/teachers using the gloves and method with students.

FIGS. 10—A through C are PHOTOGRAPHS of interaction between students during the instruction and use of the gloves and method.

FIGS. 11—A through D are Diagrams of use of the reinforcement or teaching in the workplace.

FIG. 12—A through E are diagrams and PHOTOGRAPHS showing use by senior citizens of the teaching/reinforcing gloves and method.

### DESCRIPTION OF THE DRAWINGS—REFERENCE NUMERALS

The following list refers to the drawings:
31 general KEYBOARD RIGHT GLOVE
32 left keyboard assist glove
33 right keyboard assist glove
34 general letters on the gloves
35 home position letters on the gloves
36 high position letters on the gloves
37 low position letters on the gloves
38 glove with indications for left and right
39 prototype gloves
40 key system components
41 special gloves (repeat of 31)
42 interactive Compact Disc
43 visual reinforcement—computer screen and system
44 tactile reinforcement—hands and keyboard
45 audio and music—voice and music instructions
46 classroom instruction—teacher and student
47 voice instruction—teacher direct
48 test scores and feedback—progress and areas for improvement
49 Flash cards and the like
50 auxiliary practice keyboard
51 internet connection(s)
52 Demonstration graphics of interactive Compact Disc
53 progress numbers
54 instruction block
55 information block
56 words to type
57 test/progress results
58 next steps
59 student
60 parent/grandparent, etc.
61 computer lab
62 work place employee
63 senior user
64 grand child/young person

### DETAILED DESCRIPTION OF PREFERRED EMBODIMENT

The present invention is a KEYBOARDING GLOVE AND METHOD TO TEACH KEYBOARDING SKILLS that has various features and options to enhance its use. These features are built-in to or integrally attached to the device and method described in this application. It is a combination of a KEYBOARD RIGHT GLOVE 31 and interactive CD 42. These will naturally require a computer system and screen 43 to fully utilize the glove device 31 and methodology herein described.

A person having ordinary skill in the field of gloves appreciates the various materials and component parts that may be used to physically permit KEYBOARD RIGHT GLOVE 31 to be produced and utilized. It is anticipated that the material is a light and flexible cotton, rayon, polyester, poplin, or other similar material. The glove 31 needs to “breathe” and not cause excessive perspiration. The glove is sized across many sized hands in order to have a snug yet comfortable fit to the student's hands.

The improvements over the existing art are providing a device and method that: (1) is a Full Kinesthetic system and incorporates the glove with Music/visual/audio/tactile components of the instruction; (2) is a method that reinforces learning and skills; (3) is an inexpensive design; (4) is for all ages, a simple and a repeatable process; and is high energy learning.

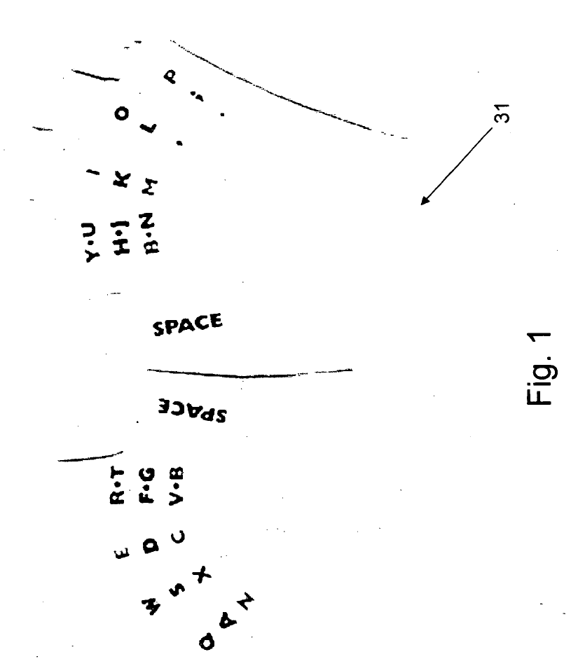

There are shown in FIGS. 1-12 complete operative embodiments of the invention. The invention generally relates to a KEYBOARD RIGHT GLOVE 31 and method.

FIG. 1 is PHOTOGRAPH of the actual invention—a KEYBOARD RIGHT GLOVE 31. This view depicts the general view.

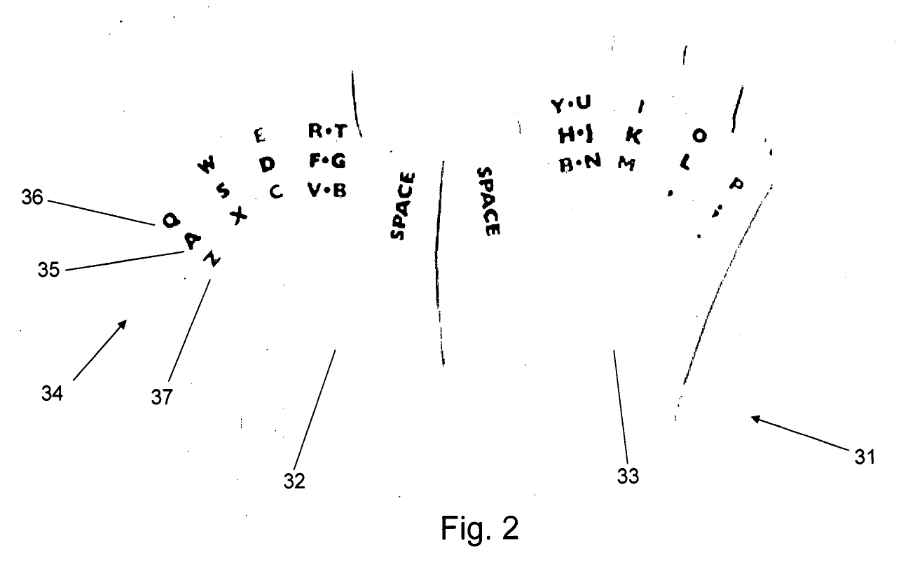

FIG. 2 is a PHOTOGRAPH of the actual device portion of this invention—a KEYBOARD RIGHT GLOVE 31 with significant parts and components identified. The general letters and symbols 34 are along the KEYBOARD RIGHT GLOVE 31 at and near the point on ones hand where the first knuckle joint permits the fingers to bend. There is a shaded home position indicator 35 where a keyboarding student normally keeps the fingers above. The higher keys indicator 36 are depicted and run across the home position 35. The lower key indicators 37 run below the home position 35. All the letters are printed, silk-screened, painted or the like to the glove 31 with a durable material that permits flexibility and withstands normal wear. One skilled in the art or glove and fabric “painting” and symbol transfers appreciates well the plethora or ways the key indicators 34 may be attached to, placed on, or imprinted on the gloves 31. Likewise, this FIG. 2 shows the left glove 32 and right glove 33 that completes a pair of KEYBOARD RIGHT GLOVES 31.

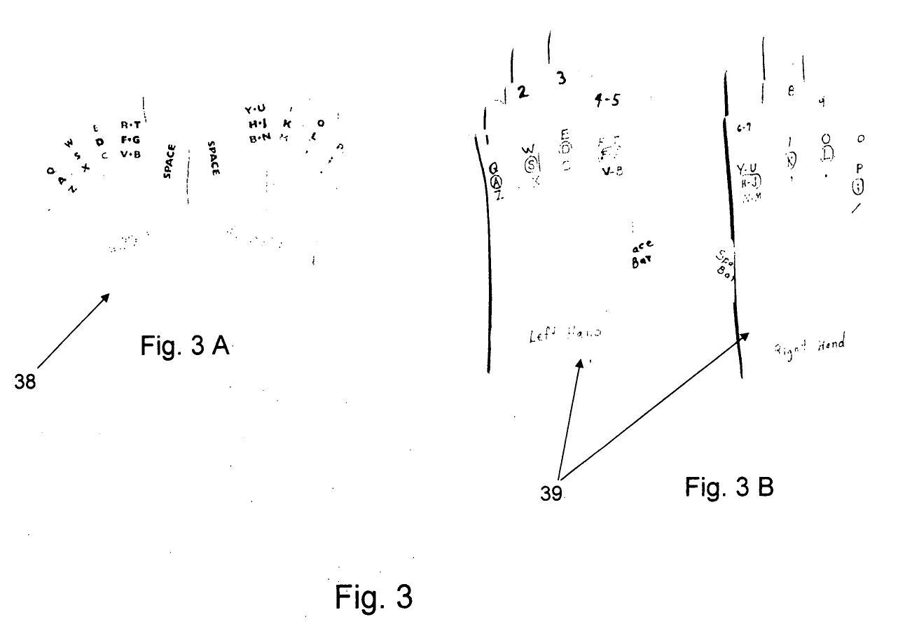

FIG. 3 is a PHOTOGRAPH of the original sample and prototype glove of the actual invention—a KEYBOARDING GLOVE. Here the left and right indicators 38 may be imprinted. The original prototypes 39 shows the home letters circled as an alternative to shading as is in the preferred embodiment.

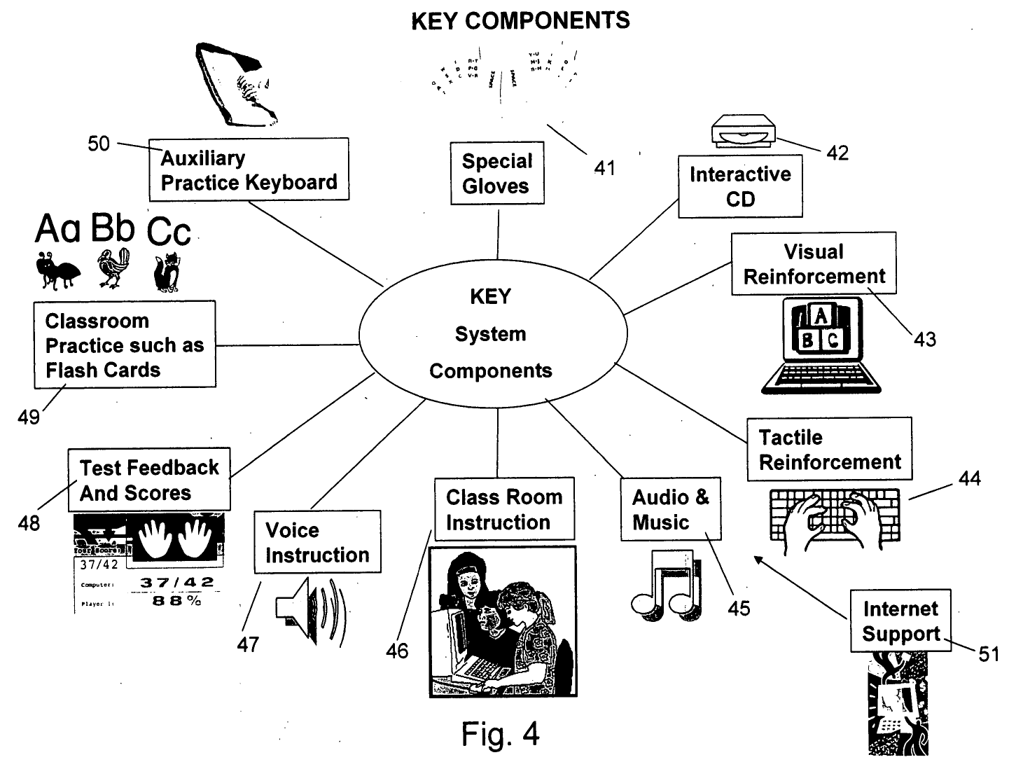

FIG. 4 is a DIAGRAM of the major components used with the KEYBOARD RIGHT GLOVE 31 in the advanced method to teach keyboard skills to all age groups. The base components are the special KEYBOARD RIGHT GLOVES 41 (31) and the interactive CD 42 which contains many of the other components. The computer system 43 provides the mechanism to play the instructional CD 42 and provide visual reinforcement via the screen. The tactile reinforcement 44 is shown with the hands and keyboard. The audio and music portion 45 of the CD is demonstrated by the music notes. Classroom instruction 46 is shown in the operation drawings described below and in the operation portion of this specification. Specific and repeated voice instruction 47 is a component on the CD 42 as well as instruction and feedback from the teacher/instructor. Test score feed back 48 is provided on the interactive CD 42 to provide the student immediate feedback as to progress and areas for improvement. Flash cards 49, mentioned earlier, are helpful with younger students to assure they know and recognize the alphabet. The use of internet connections 51 between the student and teachers is anticipated, especially for home schoolers and distant learning situations. It also may be incorporated to have homework sessions reported to the classroom teachers in a paperless manner. Finally, an auxiliary keyboard 50 may provide a means to practice outside the classroom environment if desired by the student.

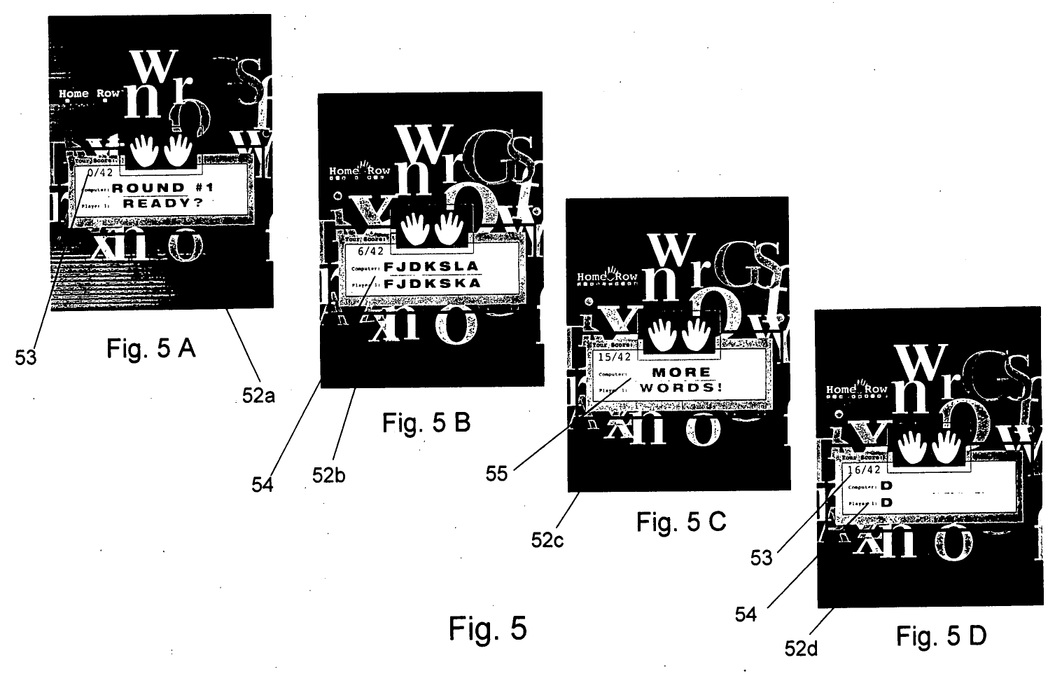

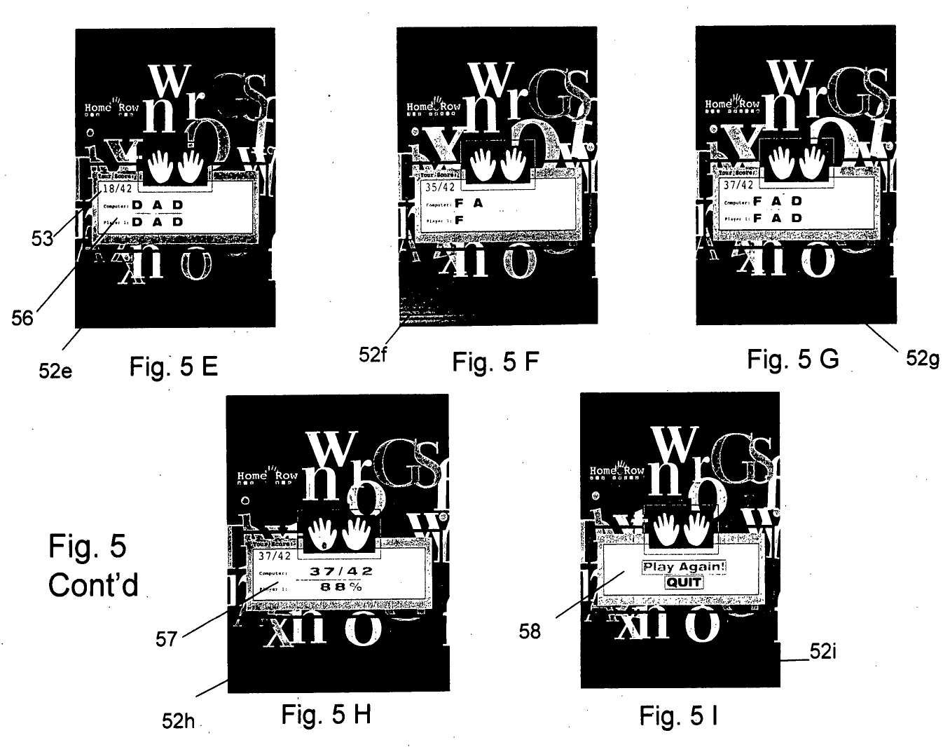

FIGS. 5—A through I are screens from an actual interactive demonstration Compact Disc 42 of the interactive keyboard instruction method described herein. In FIG. 5A, the screen graphics 52 (a through i) are depicted as they progress through the lesson on the CD 42. The first is a “ready prompt” 52a. One notes well that each screen also has the current score 53 depicted in the corner of the screen. FIG. 5B shows a screen 52b with a lesson portion 54 of the initial home row 34 letters being called for and inputted.

Throughout this whole lesson, the music and rhythm 45 keeps the student on track as the voice instructions 47 requests the next letter to be inputted. With FIG. 5C the information block 55 advises that words are about to be inputted as shown on screen 52c. In FIG. 5D the screen 52d shows the beginning of the word input instruction 54 as well as the current score 53.

FIG. 5 continues with the FIG. 5E screen 52e completing the word on the instruction block 56. On the next two screens 52f and g the FIGS. 5F and G repeat a word entry. FIG. 5H shows the final session result in the block 57 and then FIG. 5I the block 58 queries the student if he or she wants to play again or quit the session.

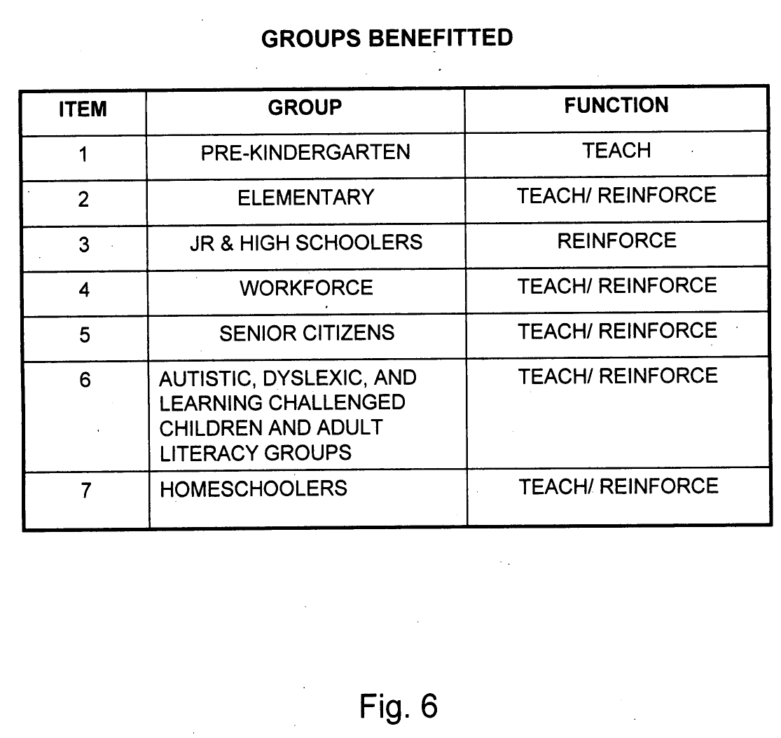

FIG. 6 is a table describing the various groups that benefit from the keyboard glove and method. One notes the wide age group contemplated to use the KEYBOARD RIGHT GLOVE 31 and method. Also, the table notes the function served may be initial teaching, reinforcing or a combination of both.

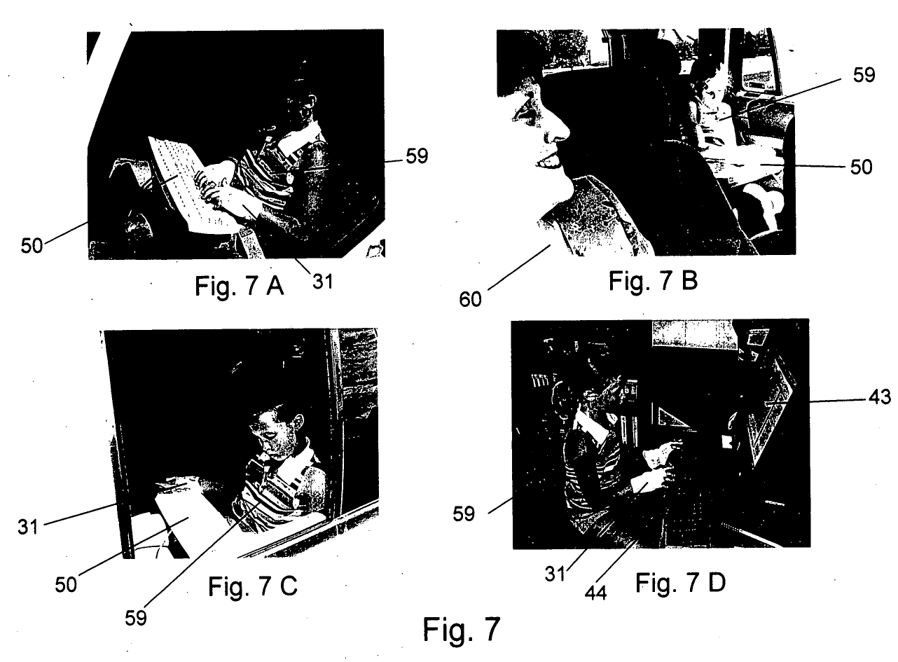

FIGS. 7—A through D are PHOTOGRAPHS of the practice keyboard being used by a student 59. FIGS. 7A and C shows a student 59 using an auxiliary keyboard 50 to practice with the Keyboard GLOVES 31. In FIG. 7B a parent, friend, or grandparent 60 looks on and encourages the practice. Here the CD 42 could be played for the voice 47 and music 45, by the Visual would not be active. It is anticipated that a full computer system 43 will be more readily available for vehicles and may make the auxiliary practice somewhat redundant. However, the auxiliary keyboard 50 is a low cost way to provide a practice means for a student 59. Finally, the student 59 (with keyboard gloves 31) returns to the full system 43 with an active keyboard 44 in FIG. 7D.

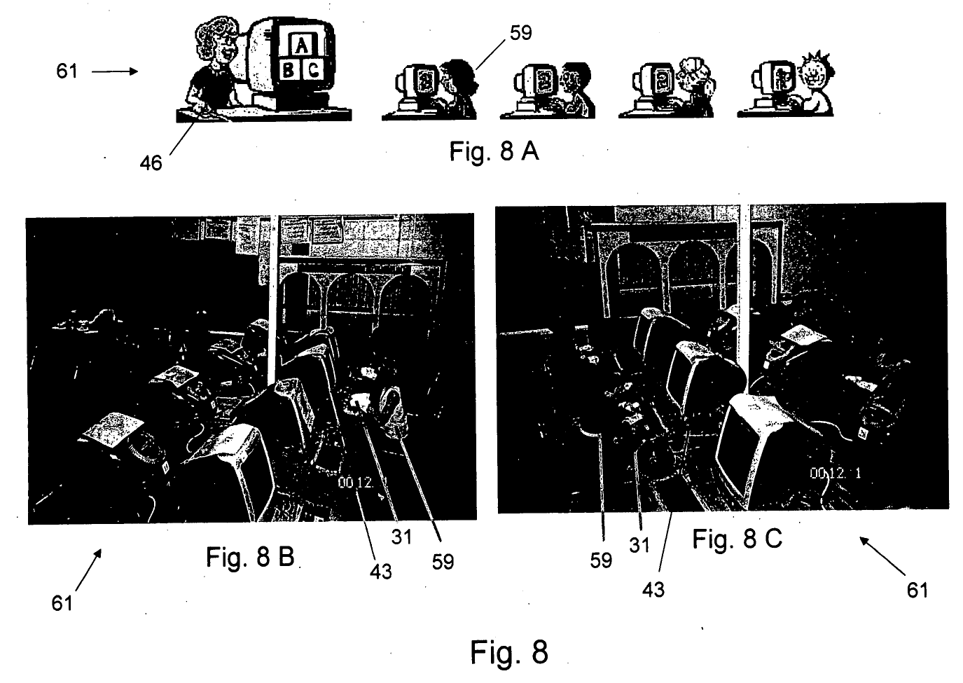

FIGS. 8—A through C are diagrams and PHOTOGRAPHS of the gloves 31 and methods used in a computer/keyboarding lab 61. Here are depicted a group of students 59 and the instructor 46 in an actual classroom setting. One notes the gloves 31 used by each student.

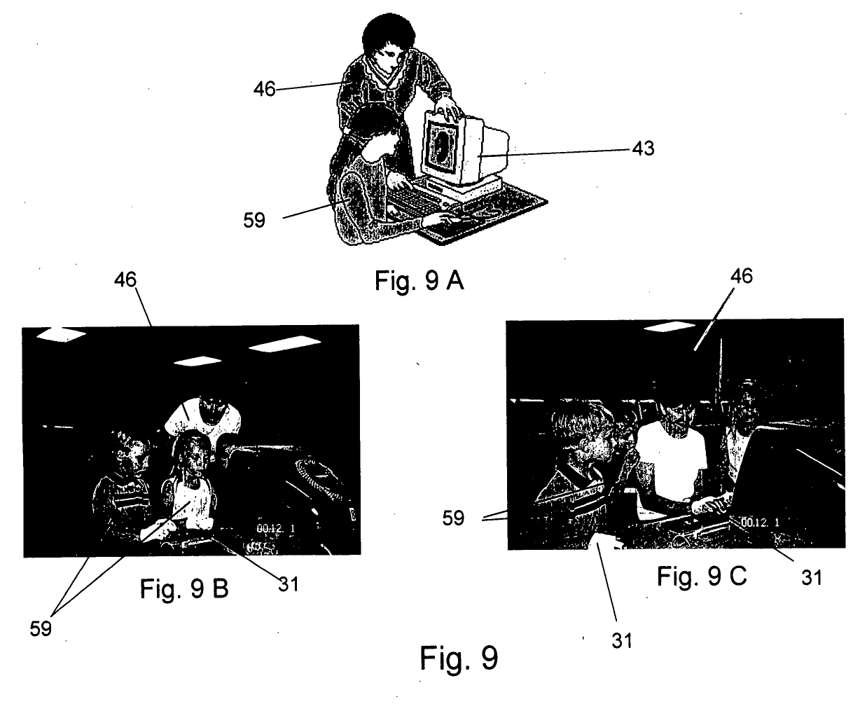

FIGS. 9—A through C are diagrams and PHOTOGRAPHS of instructor/teachers 46 using the gloves 31 and method with students 59. These are actual classroom settings where the method and gloves 31 are being developed.

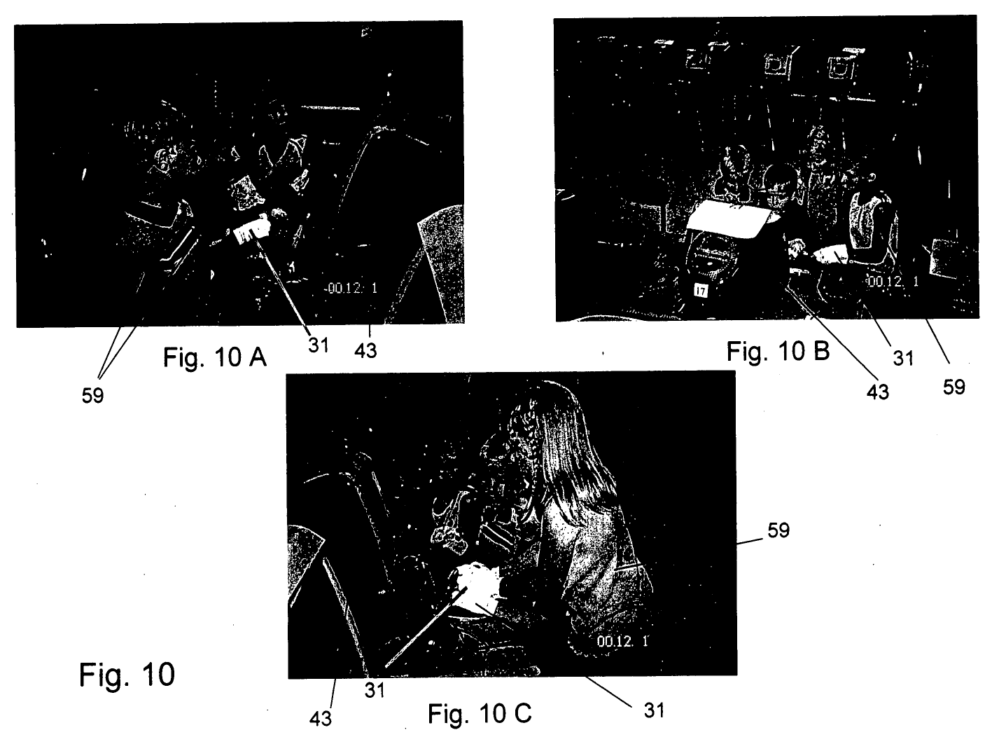

FIGS. 10—A through C are PHOTOGRAPHS of interaction between students 59 during the instruction and use of the gloves 31 and method. They are shown here gathered around a computer system 43 in the classroom.

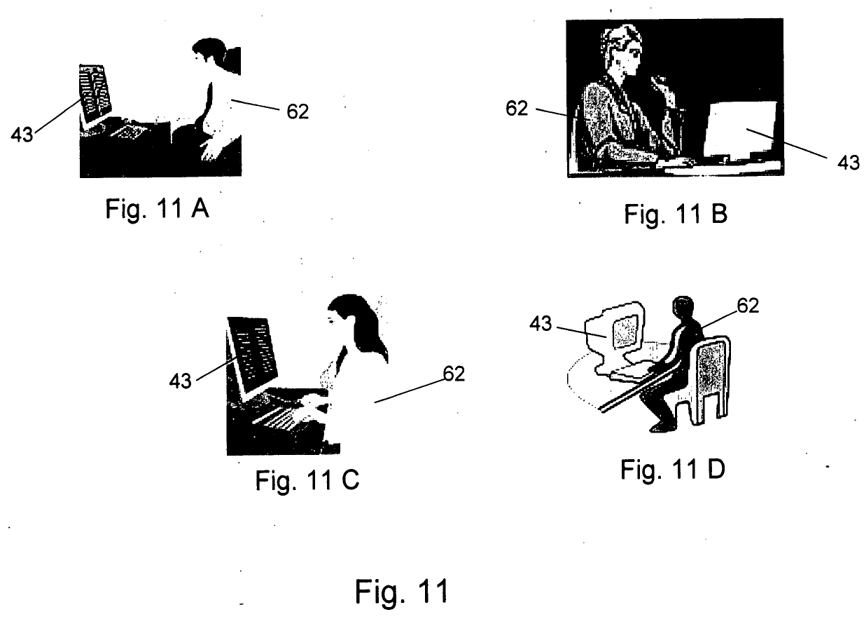

FIGS. 11—A through D are Diagrams of use of the reinforcement or teaching in the workplace. These FIGS. show the worker/employee 62 at the computer system 43. Here the gloves and method could be used to reinforce keyboard skills.

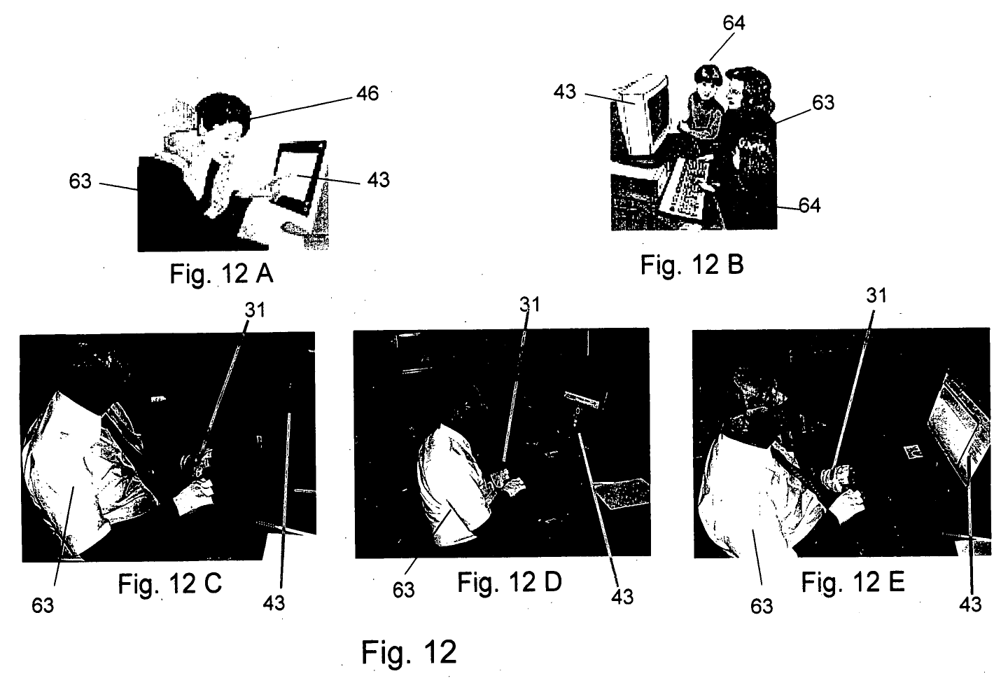

FIGS. 12—A through E are diagrams and PHOTOGRAPHS showing use by senior citizens 63 of the gloves 31 and method. One notes the presence of the computer system 43, instructor 46, and potentially a grand child or young person 64 taking interest in using the method and the gloves 31.

In total all the points and details mentioned here throughout this detailed description of the drawings are exemplary and not limiting. Other components specific to describing a KEYBOARDING GLOVE 31 and the method described herein may be added as a person having ordinary skill in the field of this invention well appreciates. The drawing and components have been focused on the parts shown in respect to the present invention.

### OPERATION OF THE EMBODIMENT

The new KEYBOARDING GLOVE 31 and method as the present invention has been described in the above embodiment. The manner of how the KEYBOARDING GLOVE 31 and method operates is described below. One notes well that the description above, the included detailed drawings, and the operation described here must be taken together to fully illustrate the concept of this invention.

The preferred operation of the glove 31 is as a device for a student 59 to wear on his or her hands and assist them in remembering and reinforcing which fingers are best used when keyboarding. The general rows 34 as described permit immediate reinforcement of the correct fingers. The interactive CD 42 shown in the drawings and described above is played on the computer system 43. The instructor/teacher 46 confirms the readiness of the student to recognize letter and words by using the flash cards 49 or other means. Then the components shown in FIG. 4 start the interplay. The visual 43, voice 47, tactile 44 and music 45 all interact and stimulate the high energy learning for the student 59. The teacher 46 and student 59 has the test score feedback 48 for progress reports and improvement planning. The alternative use of the auxiliary keyboard 50 and internet connectivity 51 was discussed above.

The overall KEYBOARD RIGHT Keyboarding method utilized may be best understood and summarized in a table format shown here.

| Step | Short | Description |
|---|---|---|
| 1 | Acquire | Obtain Gloves 32, CD 42 and auxiliary materials |
| 2 | System | Find a useable Computer system 43 or lab 61 |
| 3 | Pick | Determine students from FIG. 6 |
| | Students | |
| 4 | Determine | Confirm students 59 have skills to recognize |
| | Readiness | letters and words by flash cards 49 or other |
| | | means |
| 5 | Provide | Handout gloves 31. Assure snug but comfortable fit |
| | Gloves | |
| 6 | Instruct | Review the CD 42 and show example screen views 52. |
| | | Describe test score tracking 48 and results |
| 7 | Practice | Play the CD 42 and with the keyboard 44 and |
| | | computer system 43 begin the learning process of |
| | | visual, auditory, and kinesthetic modes of learning |
| 8 | Encourage | Practice (FIG. 7), Lab use (FIG. 8); Interaction |
| | | (FIG. 9 and 10) and home use (FIG. 12) |
| 9 | Continue | Continue with students until results are achieved |
| 10 | Repeat | Repeat Process of Acquisition through Continuance |
| | | as desired. |

Finally, the KEYBOARDING GLOVE AND METHOD TO TEACH KEYBOARDING SKILLS 31 invention has been described above in connection with what is presently considered to be the most practical and embodiments. With this description it is to be understood that the invention is not to be limited to the disclosed embodiments. On the contrary, the invention is intended to cover various modifications and equivalent arrangements included within the spirit and scope of the description.

What we claim as new and desired to be protected by Letters Patent is:

1. A business method of teaching keyboarding and typing skills comprising:
a). a teacher/instructor(teacher) acquires specially marked gloves and auxiliary materials including written information, audio and video support disks;
b). the teacher finds a useable computer in a classroom/training lab;
c). the teacher selects students for keyboarding instruction;
d). the teacher determines readiness of students; confirms students have skills to recognize letters and words by flash cards and other video and visual means; and, sets a level of desired achievement for the student;
e). the teacher provides a pair of the special Keyboard Right Gloves and assures snug but comfortable fit to the student's hands;
f). the teacher instructs the students by reviewing the instructional Compact Disk, by showing example screen views, and by describing the evaluation and scoring of test results;
g). the teacher directs the students to practice by playing the Compact Disk (CD) in conjunction with a means to input data in a keyboard;
h). the teacher encourages practice, lab use interaction with others, and home use;
i). the teacher continues to have practice sessions with students until results are achieved;
j). the teacher and the students repeat the process of learning until a desired level of keyboarding skill is achieved
whereby the improvement of the student's keyboarding skills are enhanced and accelerated by this teaching method using a combination of visual, auditory, and kinesthetic modes of learning.

2. The method according to claim 1 wherein the means to practice system is a full, desktop computer.

3. The method according to claim 1 wherein the means to practice system is a laptop computer.

4. The method according to claim 1 wherein the means to practice system is a keyboard and screen connected to a network system.

5. The method according to claim 1 wherein the means to practice system is a standalone dummy keyboard not connected to a computer and network system.

6. A keyboard learning system which is a combination of learning devices, the combination comprising:
a). a set of specially marked keyboarding gloves;
b). a means for providing audio instruction;
c). a means for providing visual instruction;
d). other support materials; and
e). other support instruction.
whereby the improvement of the student's keyboarding skills are enhanced and accelerated by this teaching system using a combination of visual, auditory, and kinesthetic modes of learning.

7. The system according to claim 6 wherein the means for providing audio and visual instruction is an interactive compact disk.

8. The system according to claim 6 wherein the other support materials comprise test feedback, flash cards, audio tapes, internet support and various types of practice keyboards.

9. The system according to claim 8 wherein one of the various types of practice keyboards is a dummy keyboard that is not electrically connected to a computer system during use.

10. The system according to claim 6 wherein the other support instruction includes internet chat rooms with the teacher and other students.

11. The system according to claim 6 wherein the other support instruction includes special classroom instruction with single and with small groups of students.

12. A pair of material glove devices for teaching a student efficient keyboarding and typing each comprising:
a) four fingers and a thumb “digit” containment means;
b). markings on the top side (which is opposite to the palm side of the glove) of each of the digit containment means;
whereby the material snugly and comfortably encases the hand of the student so as not to encumber the flexibility of the hand encased.

13. The glove device according to claim 12 wherein the four fingers and thumb are fully encased.

14. The glove device according to claim 12 wherein the four fingers and thumb are open at the fingernail end whereby the exposed fingers and thumb have an increased tactility with the keys on a keyboard.

15. The glove device according to claim 12 wherein the snug and comfortable material is cotton.

16. The glove device according to claim 12 wherein the snug and comfortable material is silk.

17. The glove device according to claim 12 wherein the snug and comfortable material is a composite material that “breathes” and prevents excess sweating of the hands during use.

18. The glove device according to claim 12 wherein the markings are comprised of bold and bright colors.
